(19) United States
(12) Patent Application Publication
(10) Pub. No.: US 2013/0342887 A1
(43) Pub. Date: Dec. 26, 2013

(54) LIGHT MODULATOR HAVING A SWITCHABLE VOLUME GRATING

(71) Applicant: SeeReal Technologies S.A., Munsbach (LU)

(72) Inventors: Norbert LEISTER, Dresden (DE); Gerald FUETTERER, Dresden (DE)

(21) Appl. No.: 13/921,608

(22) Filed: Jun. 19, 2013

(30) Foreign Application Priority Data
Jun. 22, 2012 (DE) 10 2012 105 487.8

(51) Int. Cl. G02F 1/01

(52) U.S. Cl. CPC G02F 1/01
USPC 359/254; 359/245; 359/279

(57) ABSTRACT

Spatial light modulator configured as a periodic structure of polymer grating layers arranged essentially at equal distances and intermediate spaces to form a periodic grating structure. The surfaces bounding the periodic grating structure have electrodes influencing the refractive index of the active optical medium by an electric field. The electrodes have a pixelated arrangement and can be driven independently of each other with an electrical voltage. The orientation layer thickness and grating period of the periodic grating structure are configured so that they do not correspond to the Bragg condition for the light from at least one light source, and so that for light from the at least one light source incident on the spatial light modulator the light fraction deviated owing to Bragg diffraction is less than the undeviated transmitted light fraction.

### CROSS-REFERENCE TO RELATED APPLICATIONS

This application is based on, and claims priority to, German Application No. DE 10 2012 105 487.8, filed on Jun. 22, 2012, the entire contents of which is fully incorporated herein by reference.

### BACKGROUND OF THE INVENTION

For holographic displays, as well as for other applications, fast phase modulators as well as fast amplitude modulators are required. For LC (Liquid Crystal) based modulators in many LC modes, a relationship between the thickness of the LC layer and the switching time of modulator is known. Approximately, the switching of the modulator slows quadratically with increasing thickness of the LC layer. This is because, in general, the LC molecules react to a change in the electric field more rapidly in contact with a surface than at a distance therefrom. On the other hand, however, in order to achieve a predetermined maximum value of the amplitude or phase modulation, a particular product of LC layer thickness and birefringence is required. For this reason, the layer thickness parameter can only be varied within narrow limits—for instance by selection of an LC material having a high birefringence. The layer thickness thus cannot be reduced arbitrarily when wishing to reduce the switching time of the modulator.

In order to achieve faster switching times in the case of LC based non-pixelated shutters, there are for example applications in which an LC layer thickness required for the modulation is distributed between a plurality of individual layers, with glass substrates arranged between the individual layers. For example, a fast shutter is known in the form of a sandwich of 3 LC layers, each with a thickness of 1.5 μm, embedded in glass substrates. This shutter achieves the same optical function as a single 4.5 μm thick LC layer, but has considerably shorter switching times than this individual layer. This sandwich approach, however, could not be applied in this way to a pixelated light modulator having pixels whose dimensions are small in comparison with the thickness of the glass substrates. Owing to the glass substrates, undesired diffraction effects would then occur during the light propagation between the individual LC layers, which would entail crosstalk between the individual pixels. For example, a typical pixel pitch in a light modulator for a holographic display is around 30 micrometers, while the typical thickness of a glass substrate, such as is used in the display industry, is 700 micrometers.

Polymerizable LC structures (PDLC: Polymer Dispersed LC Structures), in which a polymer network stabilizes a particular orientation of the LC molecules, are also known, which can likewise have a positive effect on the speed of a switching process. In general, however, such crosslinking leads to problems in relation to scattering during the light transmission.

On the other hand, switchable volume gratings which have a grating structure consisting of a regular polymer network and LC layers lying in-between are known. Such an arrangement is described, for example, in the publication by Caputo et al., “POLICRIPS switchable holographic grating: A promising grating electro-optical pixel for high resolution display application”, Journal of Display Technology, Vol. 2, No. 1, March 2006, p. 38 ff. Another such application is described in the publication by Sakhno et al. “POLIPHEM—new type of nanoscale polymer-LC switchable photonic devices”, Proc SPIE Vol. 5521, p. 38 ff, 2004.

Both publications describe a type of switchable Bragg grating, which is used for light deviation and, depending on the switching state, transmits a smaller or larger incident light fraction either deviated or undeviated. It is also described that this grating can be switched in a pixelated fashion. In this way, the incident light would thus also be locally transmitted either deviated or undeviated, depending on the switching state of the pixel. The arrangement then corresponds to a Bragg grating driven in a pixelated fashion.

The Bragg condition is given by

n*λ=2*d*sin(θ),

with
n—number of the diffraction order,
λ—light wavelength,
d—distance between the grating planes,
θ—angle between the incident light beam and the grating planes.

For example, such a pixelated arrangement could be used as a spatial amplitude modulator when, for example, the deviated light is filtered out and only the undeviated light is allowed to pass through, or vice versa. However, an application of such a pixelated arrangement as a spatial phase modulator, i.e. one in which the phase of the light interacting with the arrangement can be modified at the pixel level, would not be possible in this form. Furthermore, such an arrangement is subject to restrictions which are due to the known properties of Bragg gratings, namely a particular angle and wavelength selectivity. Although Bragg gratings have a high diffraction efficiency of close to 100 percent in a single diffraction order, they have this efficiency only for a small angle range of the incident light and only for a small wavelength range. It is therefore to be expected, for example, that such a switchable Bragg grating cannot readily be operated uniformly with a high efficiency of close to 100 percent for red, green and blue light.

### SUMMARY OF THE INVENTION

It is therefore an object of the present invention to provide a spatial light modulator with which, in the region of the respectively activated pixel, the phase of the incident light can be modulated according to the applied voltage. In this case, the increased switching speed compared with light modulators not having such a grating structure is intended to be maintained, and wavelength selectivity is intended to be substantially suppressed.

This object is achieved according to the invention by the means of claim 1. Further advantageous configurations and refinements of the invention may be found in the dependent claims.

The spatial light modulator according to the invention is used to modulate light, from at least one light source, which interacts with the spatial light modulator, the spatial light modulator (in analogy with a switchable volume grating) being configured in the form of a periodic structure of polymer grating layers arranged essentially at equal distances and intermediate spaces, filled with an active optical medium, of the polymer grating layers, wherein the surfaces bounding the periodic grating structure are provided with electrodes with which the refractive index of the active optical medium can be influenced by an electric field, wherein the electrodes have a pixelated arrangement in a regular pattern and can be driven independently of each other with an electrical voltage, and wherein the orientation of the polymer grating layers, the layer thickness and the grating period are configured in such a way that they do not correspond to the Bragg condition for the light from the at least one light source, so that for light from the at least one light source incident on the spatial light modulator the light fraction deviated owing to Bragg diffraction is less by a predeterminable value than the undeviated transmitted light fraction and the fractions of the deviated and undeviated transmitted light respectively remain essentially unchanged when the drive voltage changes.

The angle of incidence of the light from the light source, with respect to the surface of the periodic grating structure, is in this case selected in such a way that it does not correspond to the Bragg angle of the periodic grating structure, so that the light from the at least one light source passes almost fully undeviated through the spatial light modulator, in order to influence the light in terms of its phase as a function of the respectively driven pixels.

By virtue of the regularly arranged polymer grating layers of the periodic grating structure, a layer structure of the spatial light modulator is produced which has a shorter switching time in comparison with light modulators having a single active layer. This is due to the fact that the switching time of an LC based light modulator increases with the square of the thickness of the active LC layer. This suggests that the active layer should be subdivided into a plurality of sublayers. However, subdivision by glass substrates as separating layers leads to undesired diffraction effects at the separating layers, which cannot be tolerated for example in the case of a phase modulator for a holographic display.

In comparison with light modulators having a plurality of active layers, which are separated by glass substrates, by virtue of the present invention undesired diffraction effects between the individual layers, and therefore crosstalk between neighboring pixels, are avoided.

Advantageously, for the production of such a periodic grating structure, it is possible to use known methods for the production of switchable volume gratings, such as described in the aforementioned publications by Caputo et al. or Sakhno et al. In these, a grating is recorded optically by interference of two laser beams in a recording medium. The grating period can, for example, be adapted by modifying the angle between the two interfering laser beams. The orientation of the grating planes in the recording medium can be adapted by varying the angle of the recording medium with respect to the two laser beams during the exposure.

The layer thickness of the grating structure can likewise be adapted to the requirements of a light modulator for phase or amplitude, for example by using spacers of suitable size.

The grating planes of the periodic grating structure may in this case selectively be arranged perpendicularly or parallel (or in the general case even inclined) to the surface of the recording medium by suitable orientation of the recording medium and the lasers.

In conjunction with at least one polarizer arranged before and/or after the modulator layer, depending on the intended use, amplitude modulation or a phase modulation of the incident light can then be produced.

The light modulator may also be used to modulate light from a plurality of light sources of different wavelengths, for example at least one red, one green and one blue light source. In this case, the period and inclination angle of the periodic grating structure are selected in such a way that they do not correspond to the Bragg condition for the angle of incidence of any of the three light sources, so that the light from the at least three light sources passes almost fully undeviated through the light modulator, in order to influence the light in terms of its phase as a function of the respectively driven pixels. In particular, this can be achieved well when using narrowband LED or laser light sources, such is the case for example for a holographic display.

Advantageously, the grating planes of the periodic grating structure are arranged perpendicularly to the surface of the light modulator, and the grating period is selected to be less than the wavelengths of the light sources. The walls and intermediate spaces of the polymer grating layers of the periodic grating structure may in this case have different widths.

In the light modulator according to the invention, instead of the conventional ITO based electrodes (ITO: Indium Tin Oxide), it is also possible to use WGP based electrodes (WGP: Wire Grid Polarizer), which, besides the function as an electrode, also act as a polarizer, or as an analyzer for polarized light. This has the advantage that separate polarizers are not necessary when using the light modulator according to the invention as an amplitude modulator. Further details of this are given in the figure description of FIG. 7. In this regard, not only can the light modulator according to the invention be equipped with WGP based electrodes, but in principle any type of light modulator can be equipped with WGP based electrodes.

Very generally, WGP electrodes may also be used as electrodes in light modulators which are not formed according to the light modulator according to the invention.

Such displays having image diagonals of more than 8 inches have electrode structures with structure widths ≧1 μm. These structure widths can still be produced by contact copy. In this case, so far as is known, amplitude gratings are exclusively used. With a currently used UV exposure wavelength of, for example, λ_{exp.}=365 nm (i-line), the resolution limit is therefore reached. The minimum structure width is referred to as a CD (critical dimension). When using the light modulator according to the invention for holographic displays and synthetic, i.e. inscribed periods Λ_{synth.}≧1 μm, an electrode period of Λ_{E}=0.5 μm is required. With a mark-space ratio of TV=0.5, this corresponds to an electrode width of 0.25 μm. This is significantly below the resolution limit of the contact copy method currently used by display manufacturers.

One solution to this problem consists, for example, in producing the small electrode structures with significantly shorter light wavelengths than is currently the case. For example, light with a wavelength of 193 nm may be used, as well as an immersion liquid during the exposure of the electrode structures.

Another possible solution consists in producing the electrode structures of the displays and of the light modulator according to the invention by means of phase shift masks and contact copy as is known for example for reduced imaging lithography systems.

Further details of this are given in the figure description of FIGS. 11 and 12. In this regard, electrode structures not only of the light modulator according to the invention can be produced with such mask exposure, but in principle electrode structures or other structures for any type of light modulators can be produced with the aid of such mask exposure.

There are furthermore various possibilities for advantageously configuring and refining the teaching of the present invention. In this regard, reference is to be made on the one hand to the patent claims dependent on patent claim 1 and, on the other hand, to the following description of preferred exemplary embodiments of the invention with the aid of the drawing. In connection with the explanation of the preferred exemplary embodiments of the invention with the aid of the drawing, generally preferred configurations and refinements of the teaching will also be explained.

### BRIEF DESCRIPTION OF THE DRAWINGS

In the drawing, respectively in a schematic representation:

FIG. 1 shows an experimental structure for the recording of switchable volume gratings according to the prior art,

FIG. 2 shows the periodic grating structure of the active layer of a first configuration of the light modulator according to the invention,

FIGS. 3 a and b show the reorientation of the LC molecules in the intermediate spaces of the polymer grating as a function of the electric field,

FIG. 3a showing a periodic grating structure according to the prior art as a switchable volume grating,

FIG. 3b showing a periodic grating structure according to the invention with adapted parameter for layer thickness, refractive index modulation and period of the walls of the polymer grating,

FIG. 4a shows, in a diagrammatic representation, an example of the dependency of the intensity of the light fraction deviated and not deviated by the switchable volume grating as a function of the applied voltage in the case of a switchable volume grating according to the prior art,

FIG. 4b shows in comparison therewith, in a diagrammatic representation, an example of the transmitted undiffracted and diffracted light intensities as a function of the applied voltage for a light modulator according to the invention,

FIG. 5 shows, in a diagrammatic representation, the reaction profile as a function of time of a switchable volume grating according to the prior art for a change in the electric field,

FIG. 6 shows the structure of the active layer of a second configuration of the light modulator according to the invention,

FIG. 7 shows the use of WGPs as electrodes in a light modulator according to the invention,

FIG. 8 shows the use of WGPs with structured in-plane electrodes E11-12, E21-22 and E31-32 and in-plane back electrode E01-02 likewise configured in the form of a comb,

FIG. 9 shows a slightly tilted back electrode in comb form, in order to produce a rapid switch-off time toff for modulators having in-plane LCs,

FIG. 10 shows the use of WGP segments over two primary in-plane electrodes in the region of a pixel,

FIG. 11 shows the intensity profile I(x,z) for the contact copy of a grating structure behind a pure amplitude mask AM and behind a phase shift mask PSM for comparison,

FIG. 12 shows the intensity profile of the exposure light for a grating structure behind a phase shift mask for the exposure wavelength 365 nm,

FIG. 13 shows a Barker code of length 11 (first from the top) and codes generated therefrom by inversion and reflection,

FIG. 14 shows a Barker code of length 11 (top left, counting from the inside outward) and codes generated therefrom by inversion and reflection as an axisymmetric 2D distribution. The left-hand distributions are inverted distributions with respect to the right-hand distributions, and form a pairing therewith during alignment,

FIG. 15 shows a Barker code of length 11 (top left, counting counterclockwise starting at 0°) and codes generated therefrom by inversion and reflection as a radially symmetrical 2D distribution. The left-hand distributions are inverted distributions with respect to the right-hand distributions, and form a pairing therewith during alignment and

FIG. 16 shows the combination of an eleven-digit Barker code with two four-digit Barker codes.

In the figures, components which are the same or similar are denoted by the same references.

### DETAILED DESCRIPTION OF THE INVENTION

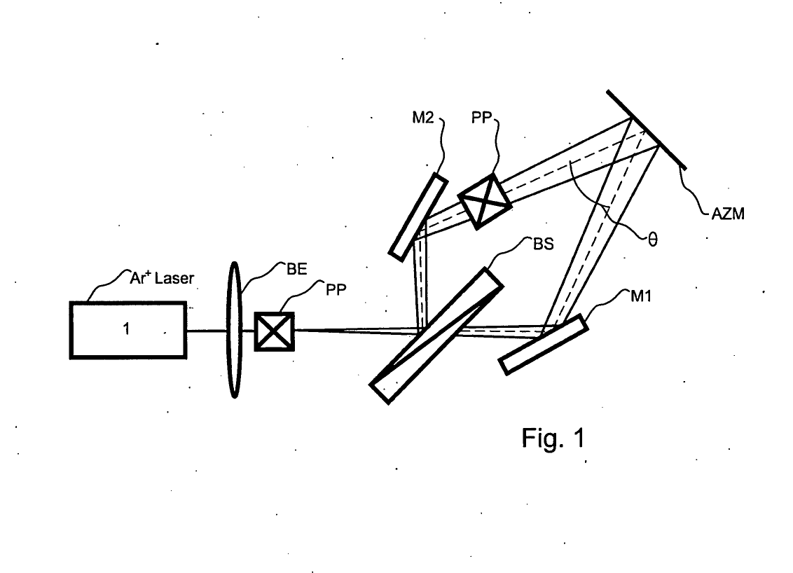

FIG. 1 shows, according to the prior art, an experimental setup for the recording of switchable volume gratings in a recording medium. Advantageously, such a setup can also be used in order to produce the light modulator according to the invention. A beam from an argon laser 1, shaped and polarized by a beam expander BE and a combination of a half-wave plate and a polarizer PP, is split by means of a beam splitter BS into two beam components. At an angle θ, which can be adjusted by means of the two mirrors M1 and M2, the two beam components strike a recording medium AZM to be exposed. In this recording medium, they generate a periodic grating structure SVG. The grating period depends on the angle θ of the beams, at which they strike the recording medium AZM. The periodic grating structure SVG generated in this way forms the polymer walls of a polymer grating, when the recording medium AZM is for example a polymerizable material. By inclination of the recording medium AZM relative to the two laser beams, it is also possible to produce walls of the polymer grating layers PMG which are inclined relative to the surface of the recording medium AZM.

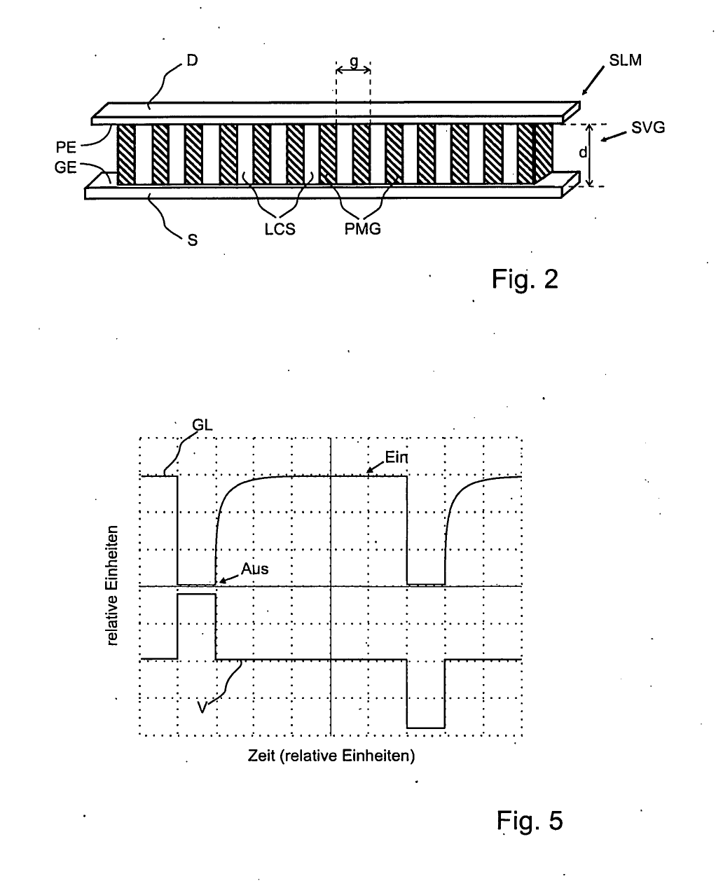

As represented in FIG. 2, as in a switchable volume grating corresponding to the prior art, the active layer of the light modulator SLM according to the invention comprises a periodic grating structure SVG of essentially equidistantly arranged polymer grating layers PMG, the intermediate spaces of the polymer grating layers PMG being filled with an active optical medium, which consists for example of liquid crystals (LC) and form a structure of liquid crystal layers LCS, the surfaces of the substrate S and of the cover glass D adjacent to the periodic grating structure SVG respectively being provided with electrodes GE, PE (not shown), which make it possible to influence the active optical medium by means of an electric field and therefore vary the refractive index of the active optical medium.

According to the invention, the electrodes PE have a pixelated arrangement in a regular pattern and can be driven independently of one another with an electrical voltage V.

According to the invention, the orientation of the polymer grating layers PMG, the layer thickness d and the grating period g are configured in such a way that they do not correspond to the Bragg condition for the light coming from the at least one light source, so that the light fraction deviated owing to Bragg diffraction is less than a predetermined value of the light from the at least one light source incident on the periodic grating structure SVG of the switchable volume grating.

Conventionally, such structures are used for the deviation of light, with a Bragg condition for the angle of incidence of the light having to be fulfilled for maximum diffraction efficiency. Fast switching times are achieved for use as Bragg gratings for light deviation. Switch-off times of less than 250 microseconds and switch-on times of from 1 to 3 milliseconds may be mentioned by way of example.

The short switching times result from the fact that the LC molecules of the active medium reorientate under the influence of an electric field faster in the vicinity of boundary layers—here formed by the polymer grating layers PMG—than at a distance therefrom.

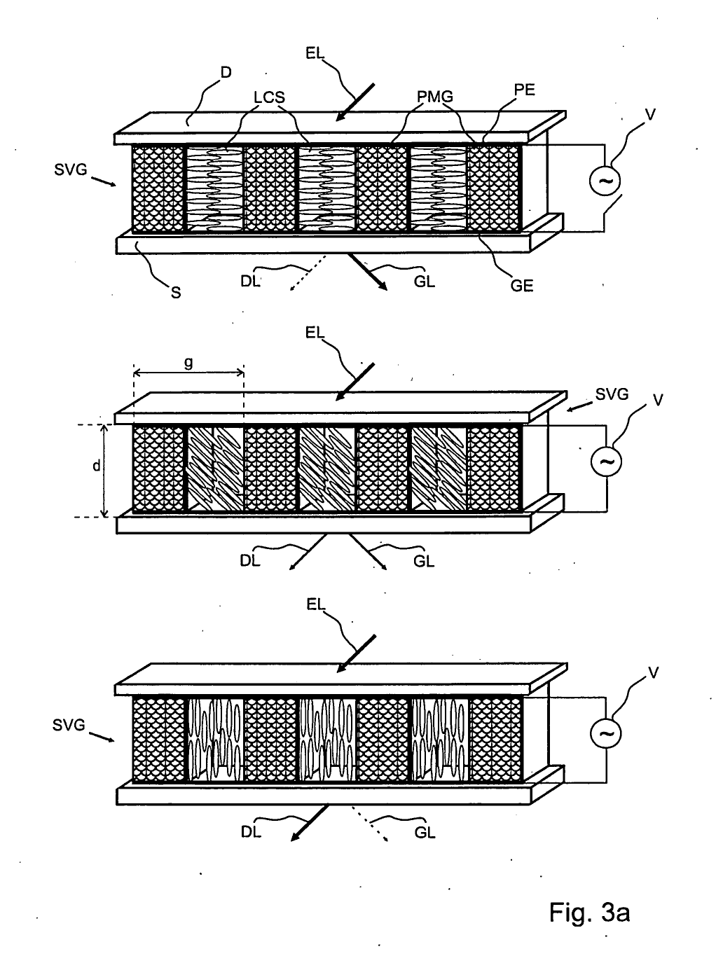

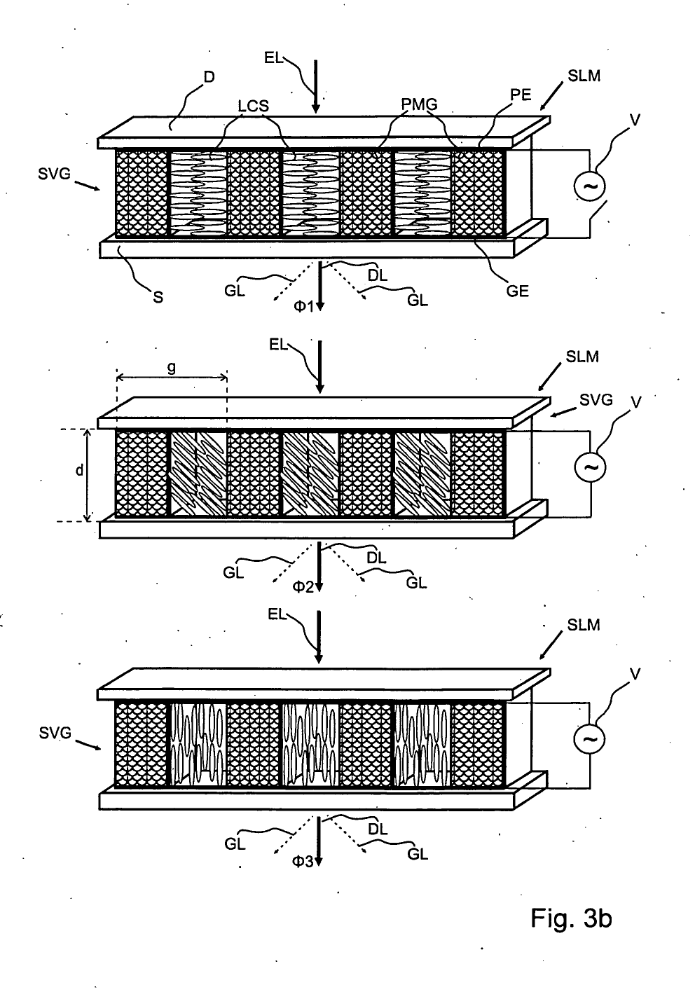

The reorientation of the LC molecules in the intermediate spaces of the polymer grating as a function of the electric field is represented in FIGS. 3a and 3b, and generally results in a shorter switching time in this arrangement.

Such an arrangement according to FIG. 3a is used according to the prior art as a switchable volume grating having a periodic grating structure SVG. In this case, the incident light EL strikes the grating planes of the periodic grating structure SVG obliquely. As a function of the voltage V applied to the two-dimensionally formed electrodes GE, PE, a different amount of light is transmitted (DL) or deviated by diffraction (GL). If the Bragg condition is satisfied for the layer thickness, refractive index modulation and incidence direction of the light EL, almost 100% of the incident light EL (here shown at the top) can be deviated into a diffraction order GL. With the maximum voltage V, conversely, almost 100% of the light is transmitted undiffracted (DL—here shown at the bottom). With a medium voltage V, light can be partially deviated and partially transmitted (here shown in the middle). Typically, the periodic grating structures of the switchable volume grating SVG have a pitch g of about 1 micrometer and a thickness d of about 10 micrometers.

FIG. 3b shows an arrangement according to the invention, having a periodic grating structure SVG which can be produced in the same way, but with a modified incidence direction of the light EL which strikes the surface of the polymer grating layers PMG perpendicularly in this case, and optionally also with parameters for layer thickness d, refractive index modulation and period g of the periodic grating structure SVG which are adapted according to the use as a light modulator.

For a conventional phase-modulating light modulator, for example, minimal layer thicknesses d of from 3 to 6 micrometers are typically required, depending on the LC material used. Yet since phase modulation of at least 2π is usually intended to be achieved, and for the functionality of the light modulator it is not disadvantageous for the modulation range to be more than 2π, the thickness d of the LC layer may also be selected to be larger. For example, it would be possible to select the typical thickness d of the periodic grating structure SVG of 10 micrometers and a typical grating period g of 1 micrometer for the phase-modulating light modulator SLM according to the invention.

For the phase-modulating light modulator SLM according to the invention as well, therefore, there is likewise a periodic grating structure SVG consisting of LC layers and polymer grating layers PMG which can differ in refractive index depending on the drive state of the LC layer.

Owing to the periodic structure of the polymer grating layers PMG, however, higher diffraction orders also occur in this case (GL—represented by dashes). Nevertheless, the intensity in these diffraction orders is modified only slightly by the orientation of the LC molecules under suitable conditions.

For example, a phase grating of predeterminable thickness d with phase stages 0 and π would, with a thickness d of 10 micrometers and a grating period of 1 micrometer for light EL incident perpendicularly to the surface, have a diffraction efficiency in the first orders GL of approximately 0.5 percent and in the zeroth order DL an efficiency of about 99 percent. Even with larger phase stages, for example 0 and 3π, the efficiency in the zeroth order DL is still approximately 90 percent.

Further suitable conditions for an intensity which is as low as possible in the diffraction orders GL are, for example, very small grating periods g of the polymer grating layers PMG below the wavelength of the light used, so that effectively only the average refractive index of the LC layers LCS and the polymer grating layers PMG acts effectively, or also a fill factor with which the polymer grating layers PMG and LC layers LCS have different widths. The latter can be influenced by the laser power during the exposure of the polymer grating layers PMG in the recording medium AZM, for example in the experimental setup shown in FIG. 1.

For the undeviated light DL, i.e. the light transmitted straight through, of suitable polarization, the optical path altered is by the orientation of the LC molecules modified under the effect of voltage. Therefore, the periodic grating structure SVG of the switchable volume grating acts according to the invention as a phase modulator for the light DL transmitted straight through.

In this case, it is to be noted that the change in the optical path in the light DL transmitted undiffracted in the zeroth order is given in thick gratings (even with grating periods of for example 1 micrometer, i.e. not only with grating periods less than the wavelength of the light) by an average of the refractive index over the walls of the polymer grating layers PMG with a fixed refractive index and the driven regions of the LC layers LCS with an effective refractive index modified by the drive voltage V.

The phase retardation of the light DL passing straight through has a different value depending on the applied voltage V (represented in FIG. 3b by φ1, φ2 and φ3, respectively).

While a change in the product of layer thickness and effective refractive index modulation (d*Δneff) is sufficient in a pixel of a conventional light modulator in order to achieve, for a predetermined wavelength of the light used, a change in the optical path which, for example, corresponds to a phase modulation of 2π, in the case of an arrangement having polymer grating layers PMG a greater change in d*Δneff of, for example, 1.5 times the wavelength is necessary in order to obtain the same spatially averaged change in the optical path and therefore the same phase modulation. How large the required change is depends in this case on the width of the walls of the polymer grating layers PMG relative to the width of the intermediate spaces LCS filled with LC.

This value of 1.5 times the wavelength for visible light can, for example, be achieved with a layer thickness d of 10 micrometers and an LC material having a birefringence of approximately 0.1.

Similarly as in the case of an ECB LC mode (ECB—Electrically Controlled Birefringence), by employing the light DL transmitted undeviated in conjunction with polarizers in the periodic grating structure SVG of the switchable volume grating, the change in the optical path can be used selectively as an amplitude or phase modulator for the transmitted (i.e. undeviated) light DL.

The walls of the polymer grating layers PMG, however, likewise contribute to the acceleration of the switching process in this arrangement according to the invention as well.

The invention is described here with reference to the example of an ECB LC mode, but is not restricted thereto. In a similar way, the use of periodic grating structures SVG consisting of polymer grating layers PMG and active LC layers LCS to accelerate the switching process is also possible for a range of other LC modes.

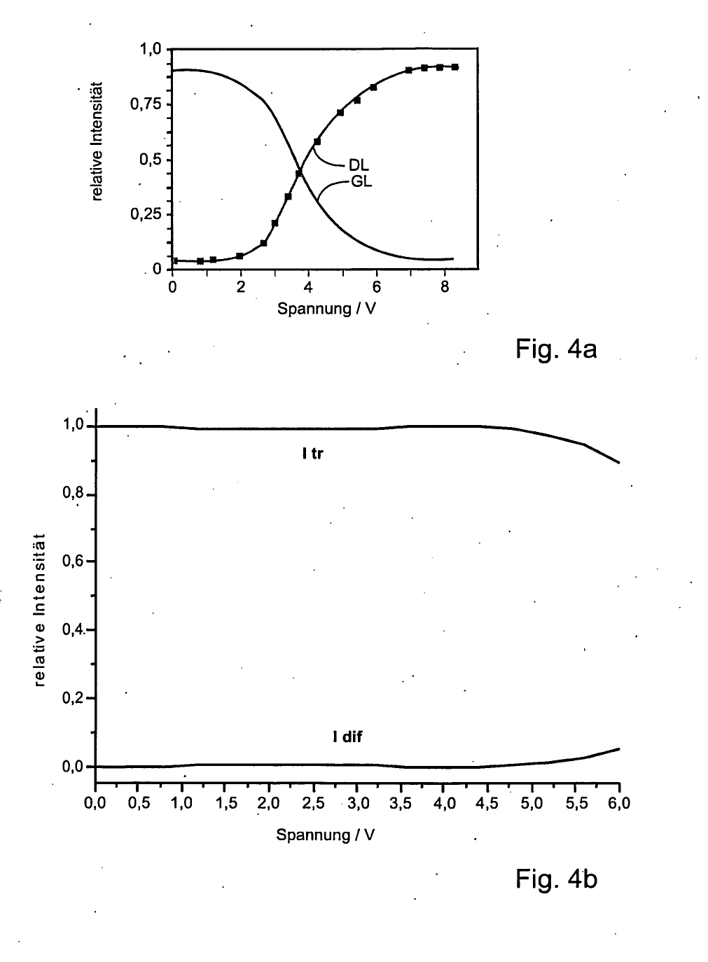

FIG. 4a shows the dependency of the intensity of the light fractions deviated (GL) and not deviated (DL) by the switchable volume grating as a function of the applied voltage V for a switchable volume grating according to the prior art. It can be seen therefrom that the ratio of these fractions can be influenced not only by the angle of incidence of the light DL but also by the applied voltage V.

The intensity of the transmitted light DL varies from almost 0 to almost 100 percent. In this way, the switchable volume grating could be used as an amplitude modulator. Use as a phase modulator, however, is not possible in this arrangement.

In comparison therewith, FIG. 4b shows an example of the dependency of the intensity of the light fractions deviated (GL) and not deviated (DL) by the switchable volume grating as a function of the applied voltage V in the case of a light modulator SLM according to the invention. The intensities of the transmitted light DL and of the diffracted light fraction GL vary only little with the voltage V.

Exemplary parameters of the light modulator, on which this representation is based, are a thickness d of the LC layer LCS of 10 micrometers and a grating period g of the polymer grating layers PMG of 1 micrometer, the polymer grating walls and the regions filled with LC respectively being about 0.5 micrometer wide. The LC material used in the example has a birefringence of approximately 0.1.

For a suitable polarization of the incident light EL parallel to the longitudinal molecular LC axis in the off state, according to the invention a phase modulation of the transmitted light DL is obtained which varies with the applied voltage V. A region is represented which approximately corresponds to phase modulation of from 0 to 2π for the transmitted light DL in the 0^{th} order in the case of a light wavelength of 532 nm.

In this region, the intensity of the transmitted light DL in the 0^{th} order changes only insubstantially. At high voltages, it decreases to approximately 90% of its maximum value. The intensity of the diffracted light GL in the two first orders then increases to about 5%. The intensity change of the light DL in the 0^{th} order could be reduced further by selecting the width of the walls of the polymer grating layers PMG to be less than the width of the regions LCS filled with LC, for example 0.3 micrometers for the width of the polymer grating walls and 0.7 micrometer for the regions filled with LC.

With polarizers which are arranged at 45 degrees to the polarization direction of the incident light EL, use as an amplitude modulator can also be carried out in this case.

The reaction profile as a function of time of a switchable volume grating according to the prior art for the diffracted light intensity GL in the event of a change of the voltage V generating the electric field is represented in FIG. 5.

A similar profile of the edges is also obtained for the transmitted light DL for the light modulator SLM according to the invention.

The surface interaction of the LC molecules is increased by the walls of the polymer grating, and faster switching times are achieved than would be the case for an LC volume grating without polymer gratings.

The configuration of the switchable volume grating according to the prior art, and for the light modulator according to the invention, as represented in FIGS. 1 to 5, relates to an arrangement having a structure of the polymer grating layers PMG which is orientated perpendicularly to the bounding surfaces of the switchable volume grating.

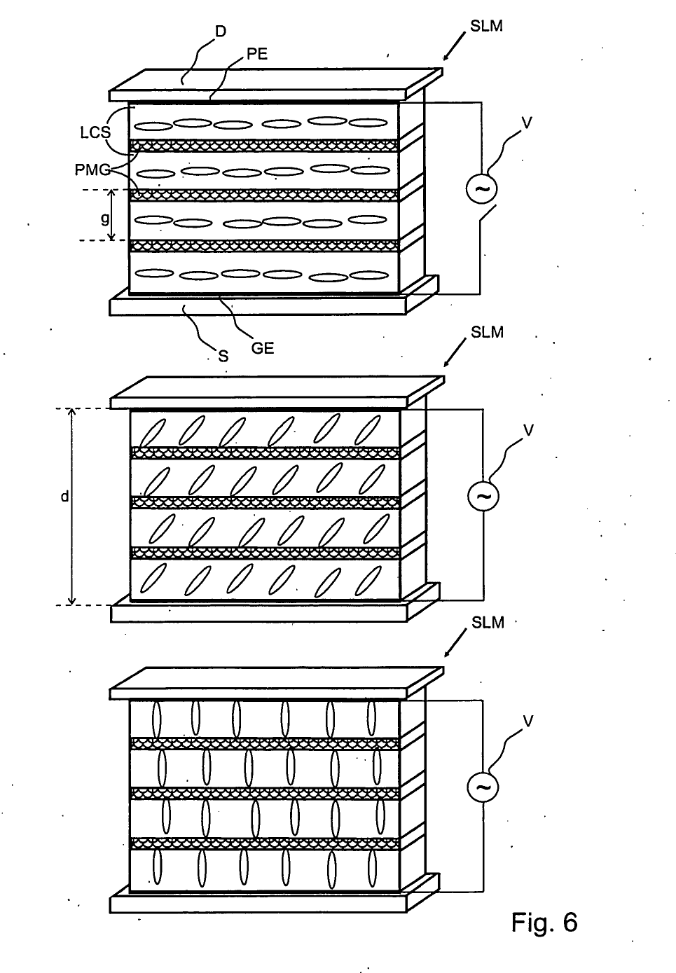

A second configuration of the light modulator SLM according to the invention, according to FIG. 6, comprises a structure having LC layers LCS and polymer grating layers PMG rotated through 90 degrees, i.e. orientated parallel to the bounding surfaces of the volume grating. Such a structure can be generated, as in the case of a reflection volume grating, carrying out exposure of the recording medium AZM with one component beam of the laser from the front and with another component beam from behind, for example after reflection on a mirror arranged parallel to the surface of the recording medium AZM. In the structure according to FIG. 1, to this end, for example, the recording medium AZM to be exposed would need to be rotated through 90 degrees. This layer structure acts with respect to the switching behavior in a similar way to a plurality of thin LC layers, in contrast to a single thick layer. In this case, however, the walls of the polymer grating layers PMG are in the thickness range of 1 micrometer or less. The walls in the micrometer range are therefore smaller than typical lateral pixel dimensions (pixel pitch) of a light modulator. In contrast thereto, glass substrates according to the prior art would be thicker or at most of the same order of magnitude as typical lateral pixel dimensions.

Owing to these very thin polymer grating layers PMG (in comparison with glass substrates as described above according to the prior art), diffraction effects due to the splitting of the active medium into a plurality of thin LC layers are negligibly small.

Advantageously, in comparison with the first configuration, this second configuration of the light modulator SLM according to the invention according to FIG. 6 does not have diffraction orders generated by the walls of the polymer grating layers PMG.

A spatial light modulator SLM according to the invention may also be operated with a plurality of, for example at least three, light sources of different wavelengths, the angles of incidence of light from all three light sources with respect to the surface of the grating respectively being selected in such a way that they do not correspond to the Bragg angle of the periodic grating structure SVG, so that the light from the at least three light sources passes almost fully undeviated through the spatial light modulator, in order to influence the light in terms of its phase as a function of the voltage V of the driven pixels.

If the grating planes of the polymer grating layers PMG are arranged perpendicularly to the surface of the light modulator, it is advantageous to select the grating period to be less than the wavelength λ of the light source(s). It is furthermore favorable for the so walls and intermediate spaces of the periodic grating structure SVG, which act as a volume grating, to have different widths.

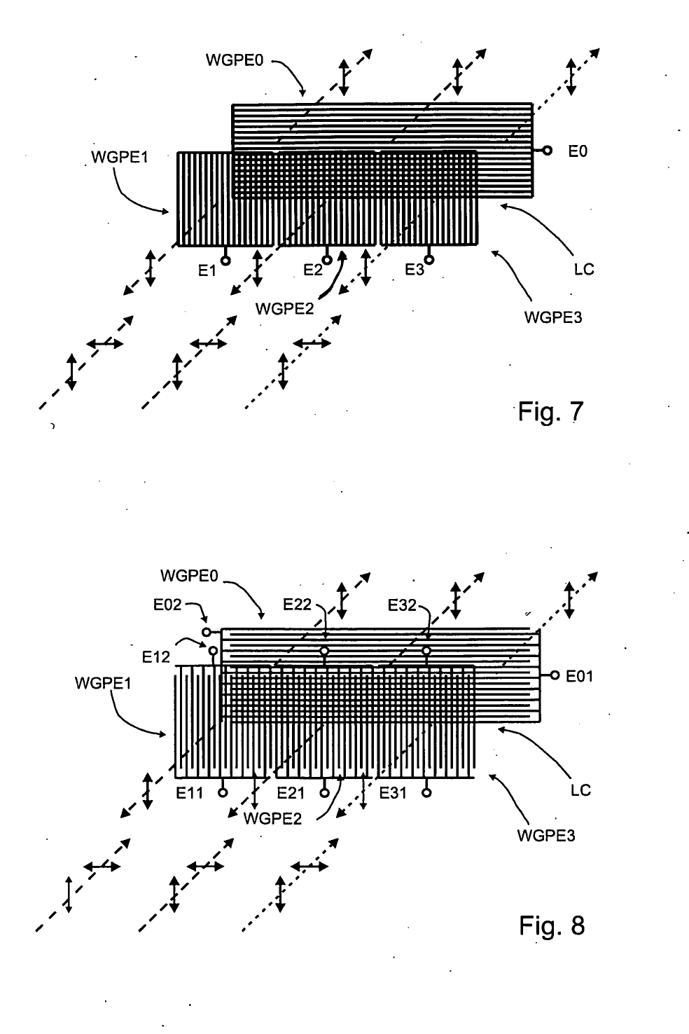

FIG. 7 shows the use of WGPs (Wire Grid Polarizers) as the electrodes in conjunction with a light modulator according to the invention. A common electrode E0 is represented, which is formed by a WGP that, for example, occupies the entire is surface of a modulator cover glass. This WGP is denoted as WGPE0. The back electrodes of the individual pixels or subpixels are formed by structured, i.e. electrically separated WGP electrodes WGPE1, WGPE2 and WGPE3. Between the WGP electrodes for the pixels having the terminals E1, E2 and E3, to which the control voltages V1, V2 and V3 are applied according to the amplitude transparency to be produced, and the common electrode which is formed by WGPE0, to the terminal E0 of which a constant voltage V0 is applied, the periodic grating structure is located, which comprises the LC layers of the light modulator according to the invention (not shown in FIG. 7) that are separated by the polymer grating layers, and which, as a function of the locally applied voltage difference with respect to the common electrode, causes rotation of the polarization plane of the light in the region of the respective pixel. By the simultaneous action of the WGP electrodes as a polarizer and analyzer, the transmitted light is controlled in the region of the respective pixel in terms of its amplitude or intensity, without separate polarizers or analyzers having to be introduced into the light modulator according to the invention. The polarization direction of the light in the region of the respective pixel is indicated by arrows in FIG. 7.

The starting arrangement, as represented in FIG. 7, of the electrodes, configured in the form of wire grid polarizers WGPs, for the light modulator according to the invention can be generalized.

Starting from the arrangement shown in FIG. 7 which generates an electric field whose field lines of which primarily extend from the electrodes E1, E2, E3 to the back electrode E0, with a different electrode arrangement it is also possible to generate in-plane fields. This is represented by way of example in FIG. 8, where the WGP is configured in the form of structured in-plane electrodes E11-12, E21-22 and E31-32, which are engaged in one another in the manner of combs.

The back electrode E0 may likewise be modified to form an electrode configured in the manner of a comb, as represented in FIG. 8. It may, however, also have a voltage applied two-dimensionally to it as in FIG. 7. Depending on the LC mode, it may even not be necessary.

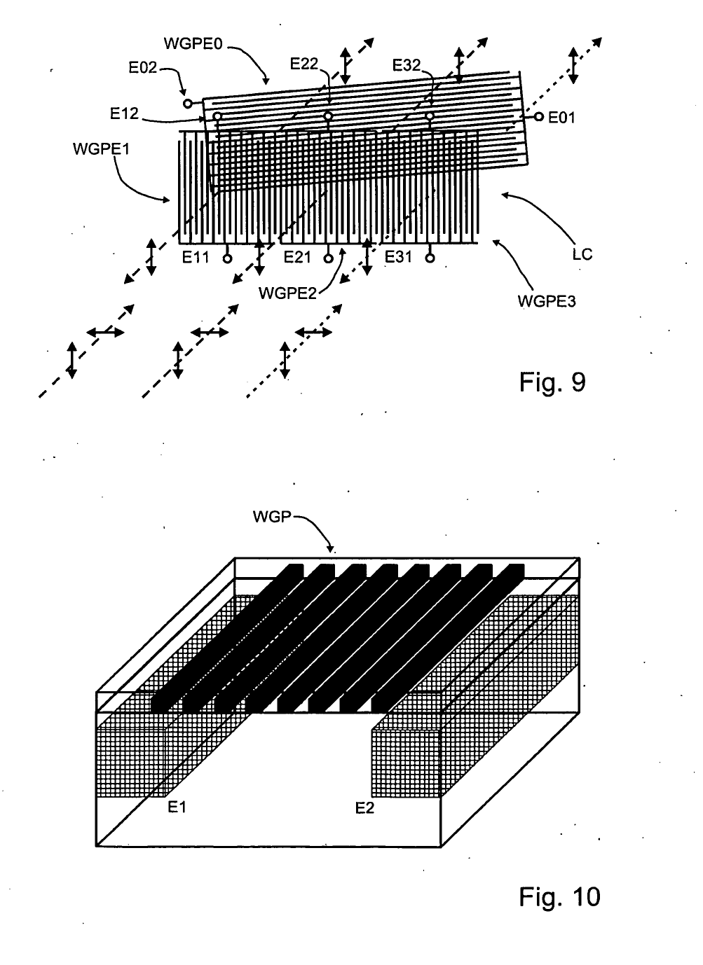

The comb-shaped back electrode E0 may, however, also be slightly tilted in relation to the electrodes E11-12, E21-22 and E31-32, in order to produce a faster switch-off of the modulator, which is characterized by the parameter t_off. This is represented in FIG. 9.

Another embodiment of WGPs, or WGP segments, in a light modulator according to the invention is represented in FIG. 10. In this case, a WGP segment assigned to the respective pixel of the modulator is used for homogenization of the primarily applied in-plane fields. The WGP segment is in this case isolated from WGP segments of other pixels.

FIG. 11 shows the intensity profile I(x,z) of the exposure light in the contact copy of a grating structure, for example for the electrodes of a light modulator according to the invention, behind a pure amplitude mask AM and behind a phase shift mask PSM for comparison.

The principle, represented in FIG. 11, of the phase shift mask PSM consists in introducing a predeterminable or alternating phase shift between neighboring structures. Diffraction images of neighboring structures are in antiphase and therefore at least partially cancel one another out within their overlap region. Potential lines at 42% of the maximum intensity existing in the field are represented in the intensity distributions of FIG. 11. This corresponds, for example, to the reaction threshold of a binary photoresist, which is used as a recording medium of the grating structure.

The geometry of FIG. 11 is not optimized. Optimization of the amplitude distribution of the mask can provide a significant improvement of the diffraction image existing behind the mask. Besides a local change in the linewidth, additional correction structures may be applied on the mask, which are not resolved by the photoresist on the recording medium. This is referred to as OPC (Optical Proximity Correction).

Further optimization can be achieved by the change from a binary phase profile, which generates the phase values 0 and π, to a phase level profile, which generates more than two phase values.

Further optimization can also be achieved by the change from the binary amplitude profile to an amplitude profile having more than two gray levels. This is referred to as APSM (Attenuated Phase Shift Mask).

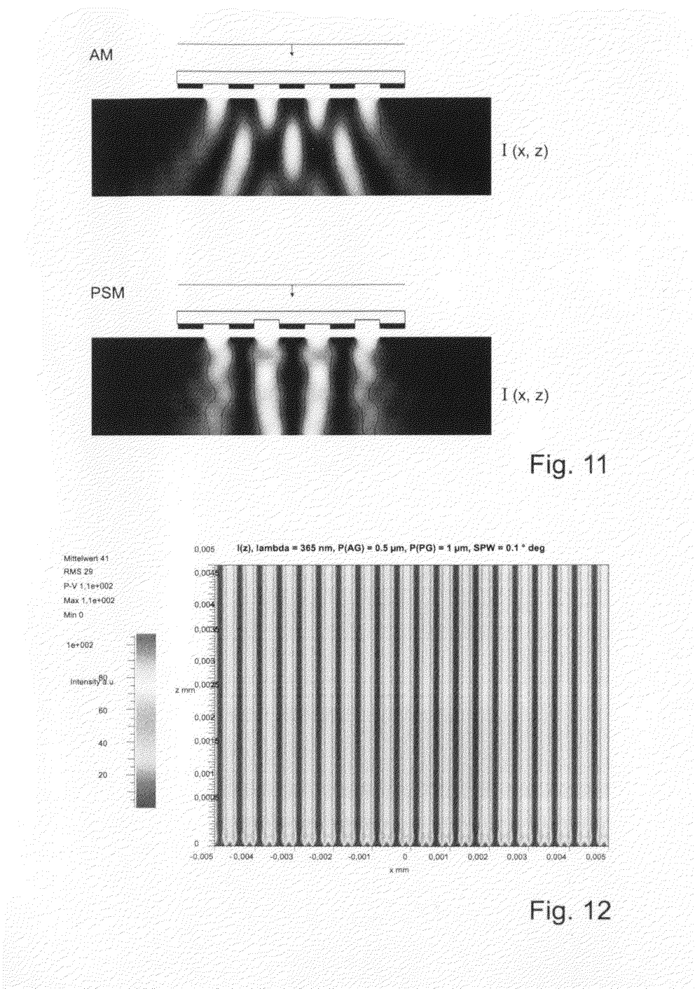

FIG. 12 represents the intensity profile I(x,z) for a grating structure to be exposed behind a phase shift mask PSM for the exposure wavelength λ_{exp.}=365 nm. The period is 0.5 μm and the mark-space ratio TV is 0.5. It can be seen that structure widths of 0.25 μm can be applied well onto the recording medium to be exposed, even over distances of 5 μm.

In the production of the electrode structures for the light modulator according to the invention by means of phase shift masks and contact copy, however, a problem arises with respect to the orientation of two substrates having electrodes with periods of Λ_{E}≦1 μm. This problem can be resolved by optimization of alignment marks.

One standardly applied method consists, for example, in using Moiré patterns for the alignment. In order to increase the resolution, for example, a 5-phase algorithm may be used, which for example theoretically makes it possible to adjust an alignment accuracy of 1/100 of the period of the electrodes along the direction of the K vector, i.e. perpendicularly to the grating lines.

Another solution is based on the electronic alignment of a capacitor:

The electrodes may be electrically connected and the alignment may, for example, involve maximizing the capacitance of the two opposite electrode comb structures. This comb capacitor may be part of a resonant circuit, so that the alignment is based on the adjustment of a frequency, which can be carried out more accurately than a conventional capacitance measurement.

According to the invention, a solution is proposed which relies on the use of improved 2D alignment markers based on Barker codes:

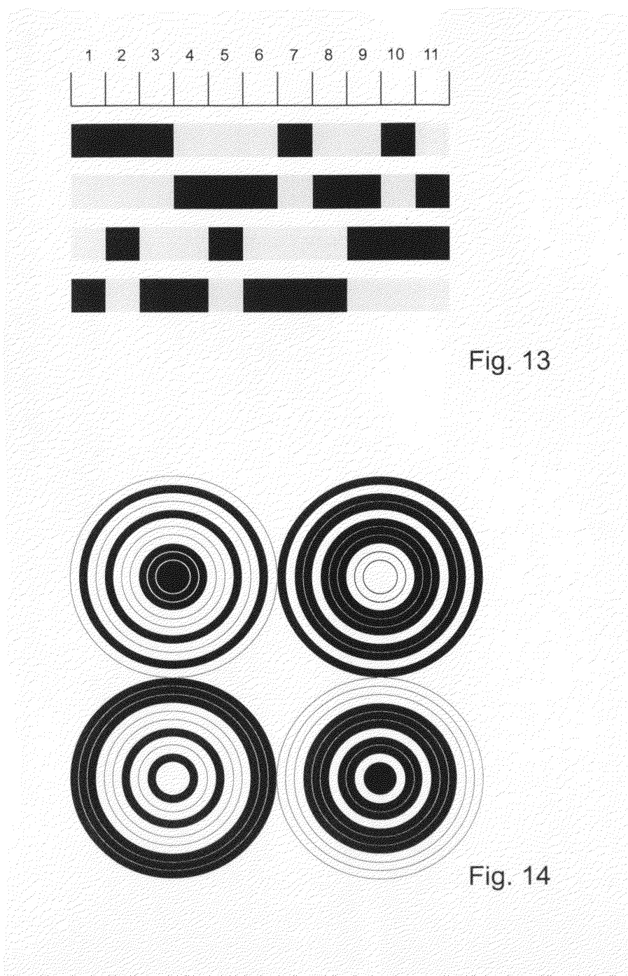

FIG. 13 shows Barker codes of length 11. Binary Barker codes are distinguished by a minimal autocorrelation function and are therefore highly suitable as point alignment markers. Apart from the 2×2 variants, however, these Barker codes are theoretically only one-dimensional. Randomly distributed binary masks also have a minor contribution of the autocorrelation up to the position of congruence.

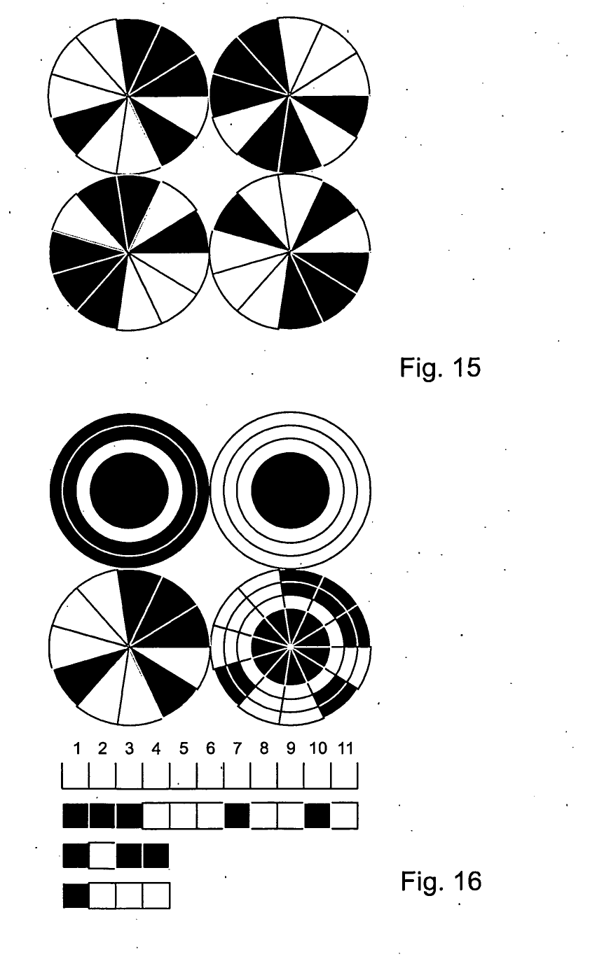

The idea according to the invention is now, however, to generate geometrically 2D Barker codes. To this end, the binary values are arranged in the form of circular rings or circular segments on a two-dimensional surface. This is represented in FIGS. 14 and 15.

Since the detection of an intensity minimum can be carried out more accurately for the human eye than the detection of an intensity maximum, mutually inverted patterns are highly suitable for being used with two mutually opposite patterns as alignment marks, on which an intensity minimum is adjusted.

The counting direction may be varied both for axisymmetric and for radially symmetrical intensity distributions. In the case of axisymmetric arrangements, for example, counting may take place from the inside outward but also from the outside inward. Cyclic permutation may also be carried out, i.e. with a constant sequence the position of the first element can be selected arbitrarily. In the case of radially symmetrical arrangements, the rotation sense of the counting may be counterclockwise or clockwise. Furthermore, cyclic permutation may be carried out, i.e. with a constant ordering of the binary pattern the position of the first element may be selected arbitrarily.

Axisymmetric 2D intensity distributions and radially symmetrical 2D intensity distributions, which are based on the one-dimensional Barker code, may be combined with one another in a wide variety of ways. One example of such a combination is represented in FIG. 16. This is the combination of an eleven-digit Barker code with two four-digit Barker codes.

Barker codes are only known up to thirteen digits. It is, however, also possible to axially and radially combine other codes, such as Willard codes or random codes, in order to obtain, in the x, y direction and in the rotation angle, an alignment mark having a small magnitude of the autocorrelation function existing outside the design position.

The method described here for the production of finely dimensioned electrode structures may also be used very generally for the production of electrode structures which can be used separately from a spatial light modulator according to the present invention.

Lastly, it should be pointed out in particular that the exemplary embodiments and application examples mentioned above merely serve to describe the claimed teaching, but do not restrict it to the exemplary embodiments and application examples.

1. A spatial light modulator for modulating light, from at least one light source, which interacts with the spatial light modulator, the spatial light modulator being configured in the form of a periodic structure of polymer grating layers arranged essentially at equal distances and intermediate spaces, filled with an active optical medium, of the polymer grating layers to form a periodic grating structure, wherein the surfaces bounding the periodic grating structure are provided with electrodes with which the refractive index of the active optical medium can be influenced by an electric field, wherein the electrodes have a pixelated arrangement in a regular pattern and can be driven independently of each other with an electrical voltage, and wherein the orientation of the polymer grating layers, the layer thickness and the grating period of the periodic grating structure are configured in such a way that they do not correspond to the Bragg condition for the light from the at least one light source, so that for light from the at least one light source incident on the spatial light modulator the light fraction deviated owing to Bragg diffraction is less by a predeterminable value than the undeviated transmitted light fraction and the fractions of the deviated and undeviated transmitted light respectively remain essentially unchanged when the drive voltage changes.

2. The spatial light modulator as claimed in claim 1, wherein the angle of incidence of light from the light source, with respect to the surface of the periodic grating structure, is selected in such a way that it does not correspond to the Bragg angle of the periodic grating structure, so that the light from the at least one light source passes almost fully undeviated through the spatial light modulator, in order to influence the light in terms of its phase as a function of the respectively driven pixels.

3. The spatial light modulator as claimed in claim 1, wherein a layer structure of the spatial light modulator, which has a shorter switching time in comparison with light modulators having a single active layer, is produced by the regularly arranged polymer grating layers.

4. The spatial light modulator of claim 1, wherein, in comparison with light modulators having a plurality of active layers which are separated by glass substrates, undesired diffraction effects between the individual layers and therefore crosstalk between neighboring pixels are avoided.

5. The spatial light modulator of claim 1, wherein the grating planes of the periodic grating structure are arranged perpendicularly or parallel to the surface of the light modulator.

6. The spatial light modulator of claim 1, wherein, amplitude modulation or a phase modulation of the incident light can be produced in conjunction with at least one polarizer arranged before or after the modulator layer or with at least one polarizer arranged before and after the modulator layer.

7. The spatial light modulator of claim 1, having at least three light sources of different wavelengths, wherein the angle of incidence of light from one of the at least three light sources, with respect to the surface of the periodic grating structure, is selected in such a way that it does not correspond to the Bragg angle of the periodic grating structure, so that the light from the at least one light source passes almost fully undeviated through the spatial light modulator, in order to influence the light in terms of its phase as a function of the respectively driven pixels, and wherein the angles of incidence of light from the at least three light sources with respect to the surface of the periodic grating structure are respectively selected in such a way that they do not correspond to the Bragg angle of the periodic grating structure, so that the light from the at least three light sources passes almost fully undeviated through the spatial light modulator, in order to influence the light in terms of its phase as a function of the respectively driven pixels.

8. The spatial light modulator of claim 7, wherein the grating planes of the periodic grating structure are arranged perpendicularly or parallel to the surface of the light modulator and wherein the grating planes of the polymer grating layers are arranged perpendicularly to the surface of the light modulator and the grating period is less than the wavelengths of light sources.

9. The spatial light modulator as claimed in claim 5, wherein the grating planes of the polymer grating layers are arranged perpendicularly to the surface of the light modulator and the walls and intermediate spaces of the polymer grating layers have different widths.
